(19) United States
(12) Patent Application Publication
(10) Pub. No.: US 2015/0009190 A1
(43) Pub. Date: Jan. 8, 2015

(54) DISPLAY DEVICE, STORAGE MEDIUM, DISPLAY METHOD AND DISPLAY SYSTEM

(71) Applicant: Masato KUWAHARA, Kyoto (JP)

(72) Inventor: Masato KUWAHARA, Kyoto (JP)

(21) Appl. No.: 13/961,007

(22) Filed: Aug. 7, 2013

(30) Foreign Application Priority Data
Jul. 8, 2013 (JP) 2013-142685

(51) Int. Cl. G09G 3/20

(52) U.S. Cl. CPC G09G 3/2092
USPC 345/205

(57) ABSTRACT

An example display device includes: a first display; a surface on which a storage device storing data is placed; a data reader that reads the data from the storage device by contactless communication; a contact detector that detects contact of the storage device with the surface; and a display controller that controls the first display to display an image based on the data read by the data reader upon detection of contact between the storage device and the surface by the contact detector.

### CROSS REFERENCE TO RELATED APPLICATIONS

The disclosure of Japanese Patent Application No. 2013-142685, filed on Jul. 8, 2013, is incorporated herein by reference.

### FIELD

The technology herein relates to displaying an image.

### BACKGROUND AND SUMMARY

There is provided a display device including: a first display; a surface on which a data storage device can be placed; a data reader that reads data from the data storage device by contactless communication; a contact detector that detects contact of the data storage device with the surface; and a display controller that controls the first display to display an image based on the data read by the data reader upon detection of contact between the data storage device and the surface by the contact detector.

The contact detector may determine a position on the surface at which the data storage device was placed; and the display controller may control the first display to display an image based on both the data read by the data reader and the position detected by the contact detector upon detection of contact between the data storage device and the surface by the contact detector.

The display controller may control the second display to display an image based on the data read by the data reader upon detection of contact between the data storage device and the surface by the contact detector.

The contact detector may further detect a position of contact of the data storage device on the surface; and the display controller controls the second display to display an image based on both the data read by the data reader and the position detected by the contact detector upon detection of contact between the data storage device and the surface by the contact detector.

The display controller may control the first display and the second display to display images that are different from each other.

The data stored in the data storage device is identification data used for identifying the data storage device, or identification data used for identifying a category to which the data storage device belongs.

The display device may further include a data writer that writes data in the data storage device using contactless communication, and the data reader reads the data written in the data storage device.

The display device may further include a calculation unit that calculates a number of times the data storage device contacts the surface, or a term during which the data storage device is in contact with the surface, and the display controller controls the first display to display an image based on the data read by the data reader and the number of times or the term calculated by the calculation unit.

The display device may further include a viewpoint detector that detects a viewpoint of a user viewing an image displayed on the first display, and the display controller controls the first display to display an image based on both the data read by the data reader and the viewpoint specified by the viewpoint detector.

The display device may further include an attitude sensor that senses an attitude of the display device, and the display controller controls the first display to display an image based on both the data read by the data reader and the attitude sensed by the attitude sensor.

The display device may further include a folding mechanism for folding the display device such that the surface and a screen of the first display face each other, and the display controller controls the first display to display an image based on both the data read by the data reader and an angle formed by the surface and the screen.

The display device may further include a direction detector that detects a direction in which the data storage device faces when the data storage device is in contact with the surface, wherein the display controller controls the first display to display an image based on both the data read by the data reader and the direction detected by the direction detector.

The first display may be configured to be disposed at such a position that the data storage device placed on the surface overlaps a screen of the first display as viewed from a front of the screen.

There is provided a computer-readable non-transitory storage medium storing a program causing a computer to execute: reading data from a data storage device by wireless communication; detecting contact of the data storage device with a surface; and displaying an image based on the read data upon detection of contact between the data storage device and the surface.

There is provided a display method including: reading data from a data storage device that stores the data using wireless communication; detecting contact of the data storage device with a surface; and displaying an image based on the read data upon detection of contact between the data storage device and the surface.

There is provided a display system including: a data storage device; and a display device that includes: a display unit; a surface on which the data storage device can be placed; a data reader that reads the data from the data storage device by wireless communication; a contact detector that detects contact of the data storage device with the surface; and a display controller that controls the display unit to display an image based on the data read by the data reader upon detection of contact between the data storage device and the surface by the contact detector.

### BRIEF DESCRIPTION OF THE DRAWINGS

Exemplary embodiments will now be described with reference to the following drawings, wherein:

FIGS. 1A and 1B show a non-limiting example of an appearance of a display device;

FIG. 2 shows a non-limiting example of a block diagram illustrating a hardware configuration of a display device;

FIG. 3 shows a non-limiting example of a process table stored in a display device;

FIG. 4 shows a non-limiting example of a block diagram illustrating major functions of a display device;

FIG. 5 shows a non-limiting example of a flowchart illustrating processing performed by a display device;

FIG. 6 shows a non-limiting example of images displayed on a display device;

FIG. 7 shows a non-limiting example of an appearance of a display device when an item is placed on the second display;

FIG. 8 shows a non-limiting example of images displayed on a display device; and

FIG. 9 shows a non-limiting example of an image displayed on a display device as viewed from the front of the first display.

### DETAILED DESCRIPTION OF NON-LIMITING EXEMPLARY EMBODIMENTS

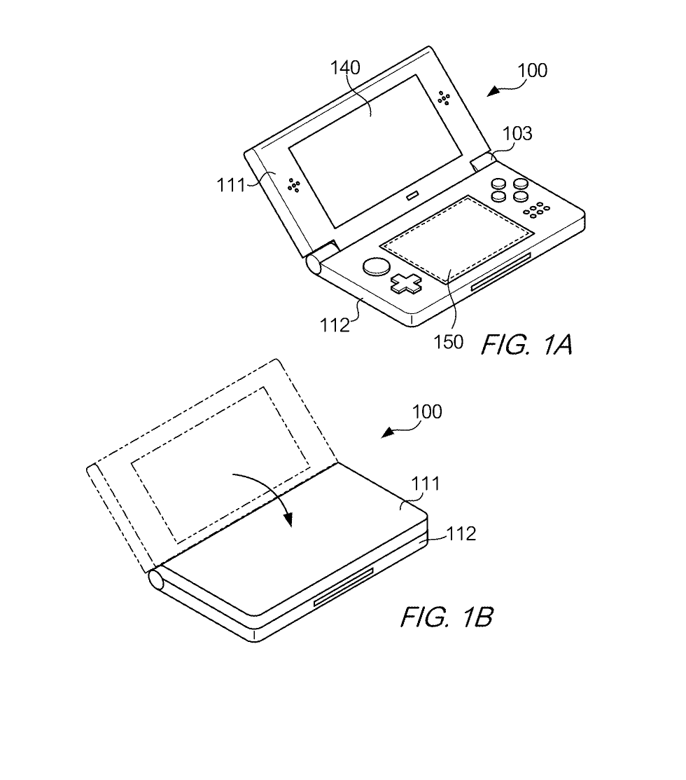

FIGS. 1A and 1B show an exemplary embodiment of an appearance of display device 100. Display device 100 includes two display devices, namely first display 140 and second display 150, and is configured to be folded such that first display 140 and second display 150 face each other. Specifically, folding mechanism 113, which may be, for example, a hinge, connects plate-shaped upper housing 111 including first display 140 and plate-shaped lower housing 112 including second display 150, and folding mechanism 113 causes upper housing 111 and lower housing 112 to be proximate to each other (in a closed state) or to be distant from each other (in an open state). FIG. 1A shows display device 100 in the open state, and FIG. 1B shows display device 100 in the closed state.

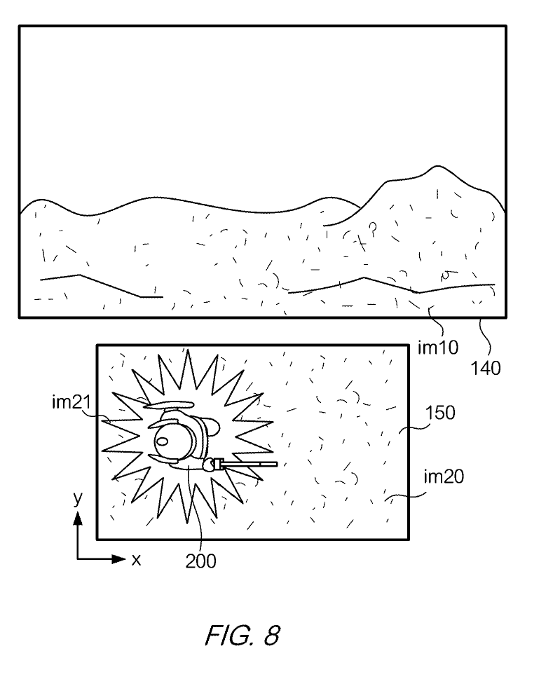

Second display 150 includes a touch screen, and also includes a near field communication unit that performs data communications in accordance with a standard of near field communication (NFC). When a user plays a role-playing game using display device 100A, the user can use an item such as a toy or figurine, that represents a character such as a main character or monster in the game, etc. (hereinafter collectively referred to as an item) together. The item has a built-in Integrated Circuit (IC) chip. The IC chip stores identification data used for identifying a category to which the item belongs (a category being, for example, “a main character” or “monster” described above). When the item is brought close to a display surface of second display 150 by an operation performed by a user, such as placing the item on the display surface, the near field communication unit of second display 150 reads the data stored in the IC chip built into the item. When the touch screen of second display 150 detects contact of the item with the display surface of second display 150, first display 140 and second display 150 display images based on the data read by the near field communication unit. By this display processing, display device 100 may control first display 140 and second display 150 to display images that are the same as each other, or may control first display 140 and second display 150 to display images that are different from each other. For example, when a user uses an item resembling a main character, first display 140 may display a background image representing a scene in which the main character appears, and second display 150 may display an image representing a visual effect emphasizing an appearance of the main character (as will be described later with reference to FIG. 8). As described above, display device 100 and item 200 constitutes a part of a display system for displaying an image.

It is to be noted that in the present exemplary embodiment a size of the display surface of first display 140 is greater than that of the display surface of second display 150; however, a size of the display surface of first display 140 may be smaller than or equal to that of the display surface of second display 150. Additionally, an aspect ratio of the display surface of first display 140 may be different from that of the display surface of second display 150.

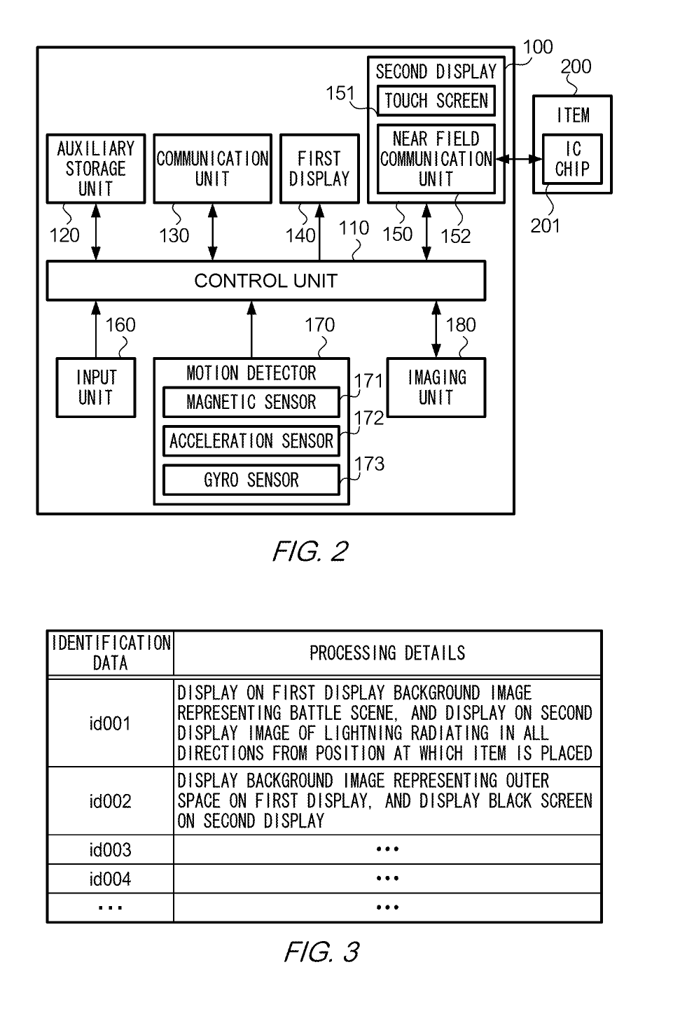

FIG. 2 is a block diagram showing a hardware configuration of display device 100. Display device 100 includes control unit 110, auxiliary storage unit 120, communication unit 130, first display 140, second display 150, input unit 160, motion detector 170, and imaging unit 180.

Control unit 110 serves as a means for controlling components of display device 100. Control unit 110 is a computer including an arithmetic processing unit such as a Central Processing Unit (CPU), a Graphics Processing Unit (GPU), or a Digital Signal Processor (DSP), a memory corresponding to a main memory, and an input and output interface used for exchange of information between the components of display device 100. Control unit 110 controls display of an image by executing a program.

Each of first display 140 and second display 150 serves as a means for displaying an image. Each of first display 140 and second display 150 includes a display panel composed of liquid crystal elements or organic electroluminescence (EL) elements forming pixels, and a driver circuit for driving the display panel. First display 140 and second display 150 display images based on image data provided from control unit 110.

Second display 150 is coupled with touch screen 151 and near field communication unit 152. Touch screen 151 forms a display surface of second display 150. Touch screen 151 serves as a means for receiving an operation performed by a user on the display surface, and for detecting contact of item 200 with the display surface. Touch screen 151 includes a sensor disposed on second display 150, and a control circuit for generating coordinate information representing a position on the display surface detected by the sensor and for providing the coordinate information to control unit 110. Touch screen 151 may employ a resistive method for detecting a position, or may employ another method, such as a capacitive method. Near field communication unit 152 serves as a means for performing data communications with IC chip 201 built into item 200 in accordance with a standard of the NFC. Near field communication unit 152 includes an antenna, etc. to facilitate communications.

Near field communication unit 152 provides data read from IC chip 201 with control unit 100, and writes data provided from control unit 100 into IC chip 201.

Input unit 160 serves as another means for receiving a user operation. Input unit 160 includes various groups of buttons. Input unit 160 provides operation information according to a user operation performed via control unit 110.

Motion detector 170 serves as a means for detecting a motion of display device 100. Motion detector 170 includes magnetic sensor 171, acceleration sensor 172, and gyro sensor 173. Motion detector 170 generates motion information representing a motion of display device 100, and provides the motion information via control unit 110. The motion information represents variation in geomagnetism detected by magnetic sensor 171 (namely, a change of direction), variation in acceleration detected by acceleration sensor 172, or variation of an angle or in angular velocity (namely, a change in an attitude of display device 100) detected by gyro sensor 173. It is to be noted that motion detector 170 need not include each of magnetic sensor 171, acceleration sensor 172, and gyro sensor 173; although motion detector 170 includes at least one of these sensors.

Imaging unit 180 serves as a means for capturing a static image or movie. Imaging unit 180 is, for example, provided with a part surrounding first display 140 of an inner surface of upper housing 111 (namely, a surface facing a user when display device 100 is in the open state). Thus, imaging unit 18 can capture an image of a user when the user views display device 100, or an image of an item placed on second display 150. Imaging unit 180 provides image data representing the captured image via control unit 110.

Auxiliary storage unit 120 is, for example, a flash memory or hard disk, or a removable recording medium such as a so-called memory card. Auxiliary storage unit 120 serves as a means for storing a program executed by control unit 110 and data used by control unit 110. Auxiliary storage unit 120 stores, as the data used by control unit 110, a process table shown in FIG. 3. The process table includes identification data used for identifying a category to which item 200 belongs, and processing details performed by display device 100 when item 200 storing the identification data is placed on second display 150. For example, when item 200 storing identification data “id001” is placed on second display 150, first display 140 displays a background image representing a battle scene for a main character symbolized by item 200, and second display 150 displays an image of lightning radiating in all directions from a position at which item 200 is placed.

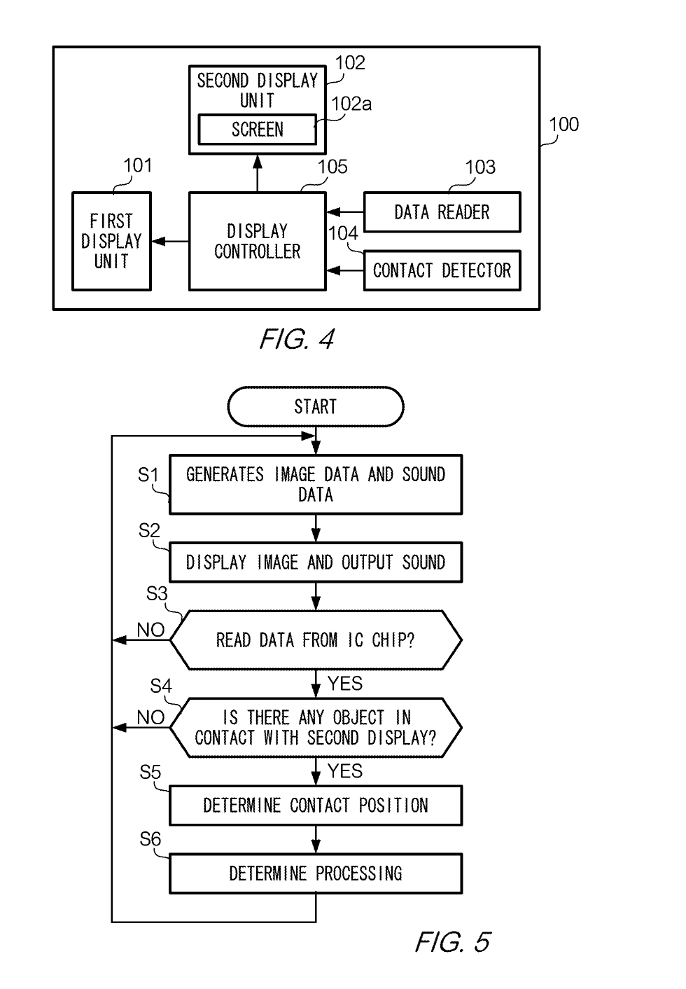

FIG. 4 is a block diagram showing a main functional configuration of display device 100. Display device 100 includes first display unit 101, second display unit 102, data reader 103, contact detecting means 104, and display controller 105. It is to be noted that display device 100 need not include all of the means shown in FIG. 4.

First display unit 101 is a means for displaying an image. First display unit 101 is implemented by first display 140. Second display unit 102 is a means for displaying an image. Second display unit 102 is implemented by second display 150. Display surface 102a of second display unit 102 is a surface on which item 200, which serves as a storage device storing data to be read, is placed.

Data reader 103 is a means for reading data from item 200 placed on display surface 102a of second display unit 102 by near field communication. Data reader 103 is implemented by near field communication unit 152.

Contact detector 104 is a means for detecting contact of item 200 with display surface 102a of second display unit 102, and a position of contact of item 200 on display surface 102a. Contact detector 104 is implemented by touch screen 151.

Display controller 105 is a means for controlling first display unit 101 and second display unit 102 to display images based on the data read by data reader 103 and the position detected by contact detector 104 when contact detector 104 detects the contact of item 200 with display surface 102a of second display unit 102. Display controller 105 is implemented by execution of a program by control unit 110.

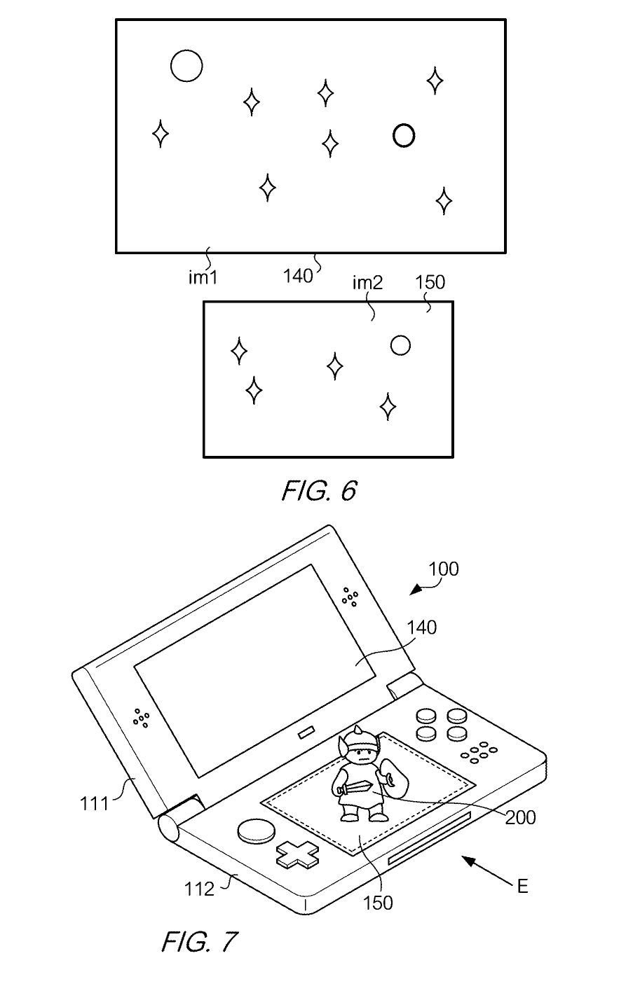

Next will be described an operation according to the exemplary embodiment. FIG. 5 is a flowchart showing processing performed by control unit 110 of display device 100. When a game program is launched, control unit 110 generates image data representing a scene of a game, and sound data representing a sound that is to be output while the image is displayed, according to a procedure described in the game program (step S1). Subsequently, control unit 110 controls first display 140 and second display 150 to display images based on the image data, and also outputs the sound based on the sound data (step S2). FIG. 6 shows an example of images displayed on display device 100 at this time in step S2. In FIG. 6, first display 140 and second display 150 respectively display image im1 and image im2 that represent outer space.

It is assumed here that a user brings item 200 (identification data “id001”) representing a main character of this game close to the display surface of second display 150 to place item 200 on second display 150. When item 200 is located in a range available for communications by near field communication unit 152 from the display surface of second display 150 (that is near field communication unit 152), near field communication unit 152 reads the identification data “id001” from IC chip 201 built into item 200, and provides the identification data via control unit 110. In this case, control unit 110 determines that data is read from IC chip 201 (step S3; YES).

However, it is uncertain at this time whether item 200 is placed on the display surface of second display 150 because near field communication unit 152 is capable of performing communications with item 200 in the range available for communications even if item 200 is not in physical contact with near field communication unit 152. Thus, control unit 110 determines whether there is any object in contact with touch screen 151 (step S4). When control unit 110 determines that there is an object in contact with touch screen 151 (step S4; YES), control unit 110 determines that item 200 is placed on the display surface of second display 150, and specifies processing details described and associated with the identification data “id001” in the process table shown in FIG. 3 (step S6). FIG. 7 shows an appearance of display device 100 when item 200 is placed on the display surface (touch screen 151) of second display 150.

Subsequently, control unit 110 generates image data and sound data based on the specified processing details in accordance with a procedure described in the game program (step S1), and outputs an image and a sound respectively based on the image data and sound data (step S2).

FIG. 8 shows an example of images displayed on display device 100. First display 140 displays background image im10 representing a battle scene for a character corresponding to item 200.

Second display 150 displays image im20 representing the battle scene for the character corresponding to item 200 as viewed from above, and image im21 of lightning radiating in all directions from a position at which item 200 is placed. In a case where X and Y coordinate axes are defined as shown in FIG. 8, X and Y coordinates of a position at which image im21 of the lightning is displayed corresponds to X and Y coordinates of a position at which item 200 is placed. It is to be noted that FIG. 7 shows item 200 facing the user; whereas FIG. 8 shows item 200 facing in a forward direction along X-axis.

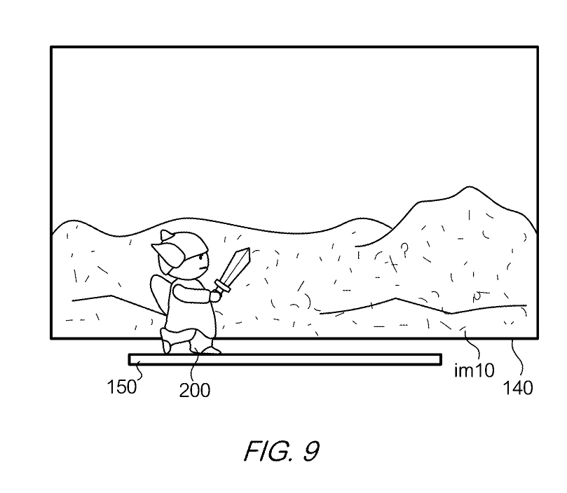

FIG. 9 shows an image displayed on display device 100 as viewed from the front of first display 140 (namely viewed in a direction indicated by arrow E shown in FIG. 7). In FIG. 9, item 200 overlaps image im10 representing a background of the battle scene; and therefore, when a user views item 200 and image im10, the user receives an impression that item 200 is in a battlefield displayed on first display 140. Accordingly, it is possible for an image to be displayed to impart to a user a realistic and interesting impression.

In addition, first display 140 is configured by folding mechanism 113 such that an attitude with respect to the display surface of second display 150 can change. In other words, first display 140 is configured to be disposed at such a position that item 200 can be seen to overlap the display surface of first display 140 as viewed from the front of the display surface of first display 140 when item 200 is placed on the display surface of second display 150. Therefore, when first display 140 displays a background image, a user can view the background image displayed on first display 140 and item 200 overlapped with each other by adjusting an open angle of display device 100 through the use of folding mechanism 13.

### Modifications

The exemplary embodiment is not limited to the foregoing exemplary embodiment. The foregoing exemplary embodiment may be modified in any of the ways described below. Two or more of the following modifications may be combined.

### Modification 1

In the foregoing exemplary embodiment, identification data used for identifying a category to which item 200 belongs is stored in IC chip 201 of item 200. However, data stored in IC chip 201 may be identification data used for identifying item 200 itself, not the category representing a grouping of items 200.

In addition, if IC chip 201 stores variable information such as a character level for a battle of the game, the variable information may be rewritten in IC chip 201. In this case, as a game proceeds, near field communication unit 152 writes in IC chip 201a changed character level for a battle when IC chip 201 is located within a predetermined range from the display surface of second display 150. When item 200 having a built-in IC chip 201 is placed on the display surface of second display 150, near field communication unit 152 reads the character level from IC chip 201. Control unit 110 controls first display 140 or second display 150 to display an image based on the character level.

### Modification 2

Control unit 110 may calculate a number of times item 200 contacts the display surface of second display 150, or a period of time during which item 200 is in contact with the display surface, and may store the number of times or period of time. In this case, control unit 110 controls first display 140 or second display 150 to display an image based on both data read by near field communication unit 152 and the stored number of times or term. For example, when the number of times exceeds a threshold, or the term exceeds a threshold, control unit 110 controls first display 140 to display an image of a new object, in addition to image im10 representing a battle scene for a character corresponding to item 200, or controls second display 150 to display the image im21 enlarged as a number of times or a length of the term increases.

### Modification 3

A technique known as a motion parallax may be utilized. Specifically, control unit 110 specifies a position of a viewpoint based on an image of user's face taken by imaging unit 180 using an image-recognition technique or the like. Control unit 110 separates each image that is to be displayed on first display 140 and second display 150 into a number of layers, which are placed from the bottom, which is distant from the user viewpoint, to the top, which is close to the user viewpoint. When control unit 110 controls first display 140 and second display 150 to display images based on data read by near field communication unit 152, control unit 110 performs display processing in which an amount of movement of a part of the image in a top side layer is increased, and an amount of movement of a part of the image in a bottom side layer is decreased, with respect to an amount of movement corresponding to the specified position of the viewpoint. This imparts to a user a feeling of being in a three-dimensional space.

### Modification 4

An attitude (positional attitude) of display device 100 may cause a change of image. Specifically, control unit 110 specifies an attitude (up, down, left, or right, or a compass direction) of display device 100 based on a motion of display device 100 detected by motion detector 170. Control unit 110 controls first display 140 or second display 150 to display an image based on both data read by near field communication unit 152 and the specified attitude. For example, control unit 110 generates an image of a virtual three-dimensional space around display device 100, and controls first display 140 or second display 150 to display a part of the image corresponding to a direction facing display device 100.

### Modification 5

An angle formed by the display surface of first display 140 and the display surface of second display 150 may cause an image to change. Specifically, a sensor for detecting an angle formed by the display surface of first display 140 and the display surface of second display 150 is provided with folding mechanism 113. Control unit 110 controls first display 140 or second display 150 to display an image based on both data read by near field communication unit 152 and the angle detected by the sensor. For example, control unit 110 generates an image of a virtual three-dimensional space around display device 100, and controls first display 140 or second display 150 to display a part of the image corresponding to a direction facing first display 140 or second display 150.

### Modification 6

A direction in which item 200 is facing may cause a change of image. Specifically, control unit 110 specifies a direction in which item 200 is facing based on an image of item 200 captured by imaging unit 180 using an image-recognition technique or the like. Control unit 110 controls first display 140 or second display 150 to display an image based on both data read by near field communication unit 152 and the specified direction. For example, control unit 110 generates an image of a virtual three-dimensional space around display device 100, and controls first display 140 or second display 150 to display a part of the image corresponding to a direction in which item 200 is facing.

### Modification 7

In the foregoing exemplary embodiment, second display 150 serves as a second display unit for displaying an image, in addition to including touch screen 151 serving as a contact detecting means, and near field communication unit 152 serving as a data reader. However, second display 150 does not have to display an image. For example, second display 150 may have a function of detecting contact without having a function for displaying an image, such as a function of a touchpad provided with a laptop computer, and may also implement a function for reading data.

In the foregoing exemplary embodiment, control unit 110 performs display processing based on a position of item 200 detected by touch screen 151 serving as a contact detecting means. However, control unit 110 does not have to perform the display processing based on the position of item 200.

### Modification 8

In the foregoing exemplary embodiment, each of first display 140 and second display 150 displays images. However, only first display 140 or only second display 150 may display an image.

In the foregoing exemplary embodiment, display device 100 executes a game program. However, any program may be executed by display device 100.

There may be provided not only a display device described in the foregoing exemplary embodiment, but also a display method, a program for implementing this method, or a display system including a display device and storage device. When the program according to the exemplary embodiment is provided, the program may be recorded in a storage medium such as an optical disk or a semiconductor memory, or alternatively, may be downloaded to a display device via a network such as the Internet.

There is no limitation as to how the functions of display device 100 are implemented using hardware or software.

The foregoing description of the exemplary embodiments is provided for the purposes of illustration and description. It is not intended to be exhaustive or to limit the present technology to the precise forms disclosed. Obviously, a large number of possible modifications and variations will be apparent to practitioners skilled in the art. The exemplary embodiments were chosen and described to best explain the principles of the present technology and its practical applications, thereby enabling others skilled in the art to understand the present technology in various embodiments, and with the various modifications as suited to a particular use that may be contemplated. It is thus intended that the scope of the technology be defined by the following claims and their equivalents.

What is claimed is:

1. A display device comprising:
a first display;
a surface on which a data storage device can be placed;
a data reader that reads data from the data storage device by contactless communication;
a contact detector that detects contact of the data storage device with the surface; and
a display controller that controls the first display to display an image based on the data read by the data reader upon detection of contact between the data storage device and the surface by the contact detector.

2. The display device according to claim 1, wherein:
the contact detector determines a position on the surface at which the data storage device was placed; and
the display controller controls the first display to display an image based on both the data read by the data reader and the position detected by the contact detector upon detection of contact between the data storage device and the surface by the contact detector.

3. The display device according to claim 1, further comprising a second display having a surface, wherein
the display controller controls the second display to display an image based on the data read by the data reader upon detection of contact between the data storage device and the surface by the contact detector.

4. The display device according to claim 3, wherein:
the contact detector further detects a position of contact of the data storage device on the surface; and
the display controller controls the second display to display an image based on both the data read by the data reader and the position detected by the contact detector upon detection of contact between the data storage device and the surface by the contact detector.

5. The display device according to claim 3, wherein the display controller controls the first display and the second display to display images that are different from each other.

6. The display device according to claim 1, wherein the data stored in the data storage device is identification data used for identifying the data storage device, or identification data used for identifying a category to which the data storage device belongs.

7. The display device according to claim 1, further comprising a data writer that writes data in the data storage device using contactless communication, wherein
the data reader reads the data written in the data storage device.

8. The display device according to claim 1, further comprising a calculation unit that calculates a number of times the data storage device contacts the surface, or a term during which the data storage device is in contact with the surface, and wherein
the display controller controls the first display to display an image based on the data read by the data reader and the number of times or the term calculated by the calculation unit.

9. The display device according to claim 1, further comprising a viewpoint detector that detects a viewpoint of a user viewing an image displayed on the first display, wherein
the display controller controls the first display to display an image based on both the data read by the data reader and the viewpoint specified by the viewpoint detector.

10. The display device according to claim 1, further comprising an attitude sensor that senses an attitude of the display device, wherein
the display controller controls the first display to display an image based on both the data read by the data reader and the attitude sensed by the attitude sensor.

11. The display device according to claim 1, further comprising a folding mechanism for folding the display device such that the surface and a screen of the first display face each other, wherein
the display controller controls the first display to display an image based on both the data read by the data reader and an angle formed by the surface and the screen.

12. The display device according to claim 1, further comprising a direction detector that detects a direction in which the data storage device faces when the data storage device is in contact with the surface, wherein
the display controller controls the first display to display an image based on both the data read by the data reader and the direction detected by the direction detector.

13. The display device according to claim 1, wherein the first display is configured to be disposed at such a position that the data storage device placed on the surface overlaps a screen of the first display as viewed from a front of the screen.

14. A computer-readable non-transitory storage medium storing a program causing a computer to execute:
reading data from a data storage device by wireless communication;
detecting contact of the data storage device with a surface; and
displaying an image based on the read data upon detection of contact between the data storage device and the surface.

15. A display method comprising:
reading data from a data storage device that stores the data using wireless communication;
detecting contact of the data storage device with a surface; and
displaying an image based on the read data upon detection of contact between the data storage device and the surface.

16. A display system comprising:
a data storage device; and
a display device that includes:
a display unit;
a surface on which the data storage device can be placed;
a data reader that reads the data from the data storage device by wireless communication;
a contact detector that detects contact of the data storage device with the surface; and
a display controller that controls the display unit to display an image based on the data read by the data reader upon detection of contact between the data storage device and the surface by the contact detector.
